(19) United States
(12) Patent Application Publication
(10) Pub. No.: US 2026/0222017 A1
(43) Pub. Date: Jul. 30, 2026

(54) METHOD AND APPARATUS FOR DETERMINING RIS ASSOCIATION IN A WIRELESS COMMUNICATION SYSTEM

(71) Applicant: Samsung Electronics Co., Ltd., Suwon-si, Gyeonggi-do (KR)

(72) Inventors: Huiwon KIM, Suwon-si (KR); Hanjin KIM, Suwon-si (KR); Seunghyun LEE, Suwon-si (KR)

(21) Appl. No.: 19/148,535

(22) PCT Filed: Jan. 12, 2024
(86) PCT No.: PCT/KR2024/000654

§ 371 Date: Jul. 16, 2025

(30) Foreign Application Priority Data
Jan. 17, 2023 (KR) 10-2023-0006851

(51) Int. Cl. H04B 7/04; H04B 17/318; H04L 5/00

(52) U.S. Cl. CPC H04B 7/04013; H04B 17/328; H04L 5/0048

(57) ABSTRACT

The present disclosure relates to a 5G communication system or a 6G communication system for supporting higher data rates beyond a 4G communication system such as long term evolution (LTE). According to one embodiment of the present disclosure, provided is a method that is performed by a terminal of a wireless communication system. The method comprises the steps of receiving, from a base station, information about a first beam set and a second beam set and information about a first threshold value, determining, on the basis of the measurement results of the first beam set and the second beam set and the first threshold value, whether the terminal is in a reconfigurable intelligent surface (RIS) association, and transmitting, to the base station, information indicating whether the terminal is in the RIS association. On the basis of whether the terminal is in the RIS association, beam sweeping is performed on the basis of any one of the first beam set and the second beam set.

### TECHNICAL FIELD

The disclosure relates to a wireless communication system and, more specifically, a method and an apparatus for efficient data transmission of a base station and a terminal in a 6th generation mobile communication (6G) system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Meanwhile, a reconfigurable intelligent surface (RIS) refers to a reflective panel or antenna capable of dynamically controlling propagation paths in the absence of a line-of-sight (LoS) link, in response to real-time variations in a wireless environment. The RIS consists of reflecting elements (REs) included in a reflective plane and may control the reflection, refraction, and absorption of incoming radio waves by forming reflection patterns defined by combinations of the phases and/or amplitudes of the radio waves.

### DISCLOSURE

### Technical Problem

In 5G/6G systems, the use of high-frequency bands raises the need for technologies to compensate for path loss. An aspect of the disclosure is to allow a terminal and/or a base station in a wireless communication system to determine an RIS association so as to more efficiently operate the system.

### Technical Solution

According to an embodiment of the disclosure, a method performed by a terminal of a wireless communication system is provided. The method includes receiving, from a base station, information on a first beam set and a second beam set and information on a first threshold value, determining whether the terminal is in a reconfigurable intelligent surface (RIS) association, based on a measurement result for the first beam set and the second beam set and the first threshold value, and transmitting, to the base station, information indicating whether the terminal is in the RIS association. Beam sweeping is performed based on one of the first beam set and the second beam set, depending on whether the terminal is in the RIS association.

According to an embodiment of the disclosure, a method performed by a base station of a wireless communication system is provided. The method includes transmitting information on a first beam set and a second beam set to a terminal, receiving a measurement result for the first beam set and the second beam set from the terminal, and determining whether the terminal is in an RIS association, based on the measurement result and a predetermined threshold value. Beam sweeping is performed based on one of the first beam set and the second beam set, depending on whether the terminal is in the RIS association.

According to an embodiment of the disclosure, a terminal in a wireless communication system is provided. The terminal includes a transceiver and a controller. The controller is configured to control the transceiver to receive, from a base station, information on a first beam set and a second beam set and information on a first threshold value, determine whether the terminal is in an RIS association, based on a measurement result for the first beam set and the second beam set and the first threshold value, and control the transceiver to transmit, to the base station, information indicating whether the terminal is in the RIS association. Beam sweeping is performed based on one of the first beam set and the second beam set, depending on whether the terminal is in the RIS association.

According to an embodiment of the disclosure, a base station in a wireless communication system is provided. The base station includes a transceiver and a controller. The controller is configured to control the transceiver to transmit information on a first beam set and a second beam set to a terminal, control the transceiver to receive a measurement result for the first beam set and the second beam set from the terminal, and determine whether the terminal is in an RIS association, based on the measurement result and a predetermined threshold value. Beam sweeping is performed based on one of the first beam set and the second beam set, depending on whether the terminal is in the RIS association.

### Advantageous Effects

According to an embodiment of the disclosure, a terminal and/or a base station may identify whether the terminal is in an RIS association, thereby operating a wireless communication system more efficiently.

According to an embodiment of the disclosure, a network may reduce reference signal overhead for a terminal being in an RIS association by configuring terminal (UE)-specific reference signals.

According to an embodiment of the disclosure, a network may increase performance gains by operating with reduced spacing between beams used for beam management when a terminal is in an RIS association.

Advantageous effects obtainable from the disclosure may not be limited to the above-mentioned effects, and other effects which are not mentioned herein may be clearly understood from the following description by those skilled in the art to which the disclosure pertains.

### DESCRIPTION OF DRAWINGS

FIG. 1 is a diagram illustrating a scenario where a terminal is located outside a shadow area in a wireless communication system including an RIS;

FIG. 2 is a diagram illustrating a scenario where a terminal is located inside a shadow area in a wireless communication system including an RIS;

FIG. 3 is a diagram illustrating an example of a configuration of synchronization signal sets for determining an RIS association according to an embodiment of the disclosure;

FIG. 4 is a diagram illustrating another example of a configuration of synchronization signal sets for determining an RIS association according to an embodiment of the disclosure;

FIG. 5 is a diagram illustrating a synchronization signal having a maximum RSRP value in each synchronization signal set for determining an RIS association according to an embodiment of the disclosure;

FIG. 6 is a sequence diagram illustrating a method by which a base station determines an RIS association, based on a measurement value of a synchronization signal at the time of initial access of a terminal according to an embodiment of the disclosure;

FIG. 7 is a sequence diagram illustrating a method by which a terminal determines an RIS association, based on a measurement value of a synchronization signal at the time of initial access according to an embodiment of the disclosure;

FIG. 8 is a sequence diagram illustrating a method by which a base station determines an RIS association, based on an RS measurement value of a terminal in a connected mode according to an embodiment of the disclosure;

FIG. 9 is a sequence diagram illustrating a method by which a terminal in a connected mode determines an RIS association, based on an RS measurement value according to an embodiment of the disclosure;

FIG. 10 illustrates a structure of a UE according to an embodiment of the disclosure;

FIG. 11 illustrates a structure of a base station according to an embodiment of the disclosure.

### MODE FOR INVENTION

Hereinafter, embodiments of the disclosure will be described with reference to the accompanying drawings.

In describing the embodiments, descriptions related to technical contents well-known in the relevant art and not associated directly with the disclosure will be omitted.

Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are provided with the same or like reference numerals.

The advantages and features of the disclosure and ways to achieve them will be apparent by making reference to embodiments as described below in detail in conjunction with the accompanying drawings.

However, the disclosure is not limited to the embodiments set forth below, but may be implemented in various different forms. The present embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, some of terms and names defined in the 3rd generation partnership project (3GPP) standards (standards for 5G, NR, long term evolution (LTE), or similar systems) may be used for the sake of descriptive convenience. In addition, terms and names used in existing communication systems or newly defined in next-generation communication systems (e.g., 6G and beyond-5G systems) to which the disclosure is applicable may also be used. Use of these terms is not intended to limit the disclosure by the terms and names, and the disclosure may be applied in the same way to systems that conform other standards, and may be changed into other forms without departing from the technical idea of the disclosure.

As used in an embodiment of the disclosure, it will be understood that the singular expressions “a”, “an”, and “the” includes plural expressions unless the context clearly indicates otherwise.

As used in an embodiment of the disclosure, the terms including an ordinal number, such as “a first” and “a second” may be used to described various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure.

As used in an embodiment of the disclosure, the term “and/or” includes any one or combinations of a plurality of relevant items enumerated.

The terms as used in an embodiment of the disclosure are merely used to describe specific embodiments, and are not intended to limit the disclosure. A singular expression may include a plural expression unless they are definitely different in a context. As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

As used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Before the detailed description of the disclosure, examples of construable meanings of some terms used herein are given below. However, it should be noted that the terms are not limited to the examples of the construable meanings as given below.

In the disclosure, a terminal (or communication terminal) is an entity that communicates with a base station or any other terminal, and may be referred to as a node, a user equipment (UE), a next generation UE (NG UE), a mobile station (MS), a device, a terminal, or the like. The terminal may include at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a medical device, a camera, and a wearable device. Also, the terminal may include at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, and an electronic photo frame. In addition, the terminal may include at least one of various medical devices (e.g., various portable medical measuring devices (blood glucose monitoring device, heart rate monitoring device, blood pressure measuring device, body temperature measuring device, etc.), magnetic resonance angiography (MRA), magnetic resonance imaging (MRI), computed tomography (CT) machine, ultrasonic machine, etc.), a navigation device, a global positioning system (GPS) receiver, an event data recorder (EDR), a flight data recorder (FDR), a vehicle infotainment device, electronic equipment for a ship (e.g., ship navigation device, gyro-compass, etc.), avionics, a security device, an automobile head unit, a home or industrial robot, a drone, an automatic teller's machine (ATM) in banks, point of sales (POS) in a shop, or Internet of things devices (e.g., light bulb, various sensors, electric or gas meter, sprinkler device, fire alarm, thermostat, streetlamp, toaster, sporting goods, hot water tank, heater, boiler, etc.). Furthermore, the terminal may include various types of multimedia systems capable of communication functions. The disclosure is not limited by the above examples, and the terminal may also be referred to by terms having the same or similar meanings.

In the disclosure, a base station is an entity that communicates with terminals and allocates resources to the terminals, and may be referred to as a base station (BS), a Node B (NB), a next generation radio access network (NG RAN), an access point (AP), a transmission reception point (TRP), a wireless access unit, a base station controller, a node on a network, or the like. Alternatively, according to function split, the base station may be referred to as a central unit (CU) or a distributed unit (DU). However, the disclosure is not limited by the above examples, and the base station may also be referred to by terms having the same or similar meanings.

As used herein, control information may be referred to as a control message or control signaling, or may be referred to as a medium access control (MAC)-control element (CE). downlink control information (DCI), uplink control information (UCI), or a radio resource control (RRC) message according to the context, and the disclosure is not limited by the above examples, and the control information may also be referred to by terms having the same or similar meanings.

As used herein, transmitting a physical channel such as a physical downlink control channel (PDCCH), a physical downlink shared channel (PDSCH), a physical uplink control channel (PUCCH), or a physical uplink shared channel (PUSCH) may mean transmitting a signal (or data) through the corresponding physical channel. In the disclosure, for example, transmitting or receiving a PDCCH may mean transmitting or receiving a signal (e.g., DCI) through the PDCCH. Alternatively, transmitting or receiving a PDSCH may mean transmitting or receiving a signal (e.g., downlink data) through the PDSCH. Alternatively, transmitting or receiving a PUCCH may mean transmitting or receiving a signal (e.g., UCI) through the PUCCH. Alternatively, transmitting or receiving a PUSCH may mean transmitting or receiving a signal (e.g., uplink data) through the PUSCH.

Conventional wireless communication systems have been designed to compensate for a wireless environment through optimization of a transmission node and a reception node. However, with the recent advancements in wireless communication technologies, research is being conducted to design systems capable of controlling the wireless environment in real time. A wireless environment constructed using such an approach may be referred to as a smart radio environment (SRE) or an intelligent radio environment (IRE). Various terms have been proposed as technologies for realizing the SRE, including reconfigurable metasurfaces, smart large intelligent surfaces (SLIS), large intelligent surfaces (LIS), reconfigurable intelligent surface (RIS), and intelligent reflecting surface (IRS). In the disclosure, the term RIS is mainly used to describe the technology.

A reconfigurable intelligent surface (RIS) refers to a reflective panel or antenna capable of controlling, in real time, a propagation path on which a line-of-sight (LoS) link does not exist, in response to a wireless environment changing in real time. The RIS is configured by reflecting elements (REs) included in a reflective plane and may control reflection, refraction, and absorption of a radio wave having reached the RIS by forming reflection patterns defined by combinations of the phases and/or amplitudes of the radio wave.

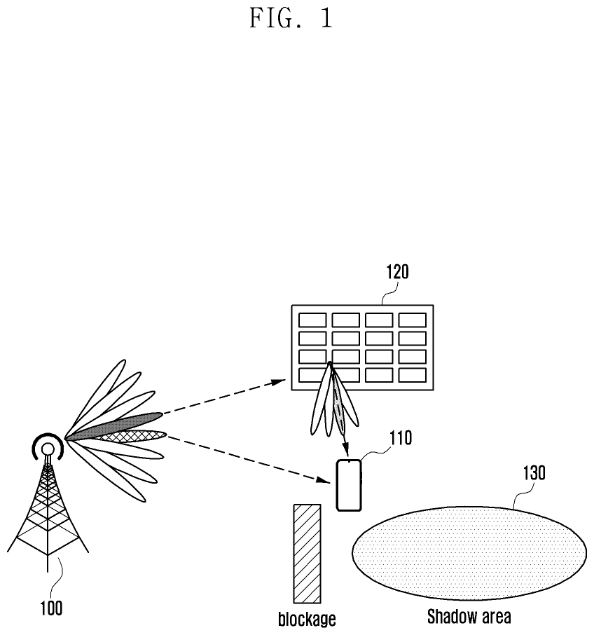

FIG. 1 is a diagram illustrating a scenario where a UE is located outside a shadow area in a wireless communication system including an RIS.

In the disclosure, an area where the strength of a signal transmitted from a base station is significantly attenuated due to a blockage in a wireless communication system may be defined as a shadow area.

Referring to FIG. 1, when a UE 110 is located outside a shadow area 130, the UE 110 and a base station 100 may be operated in a manner of directly transmitting and receiving a signal with each other. As illustrated in FIG. 1, if the UE 110 is located outside the shadow area 130, even when a signal to which a reflection pattern is applied by an RIS 120 is transmitted and received, the strength of the signal transmitted and received via the RIS 120 may be similar to that of the signal directly transmitted to and received from the base station 100.

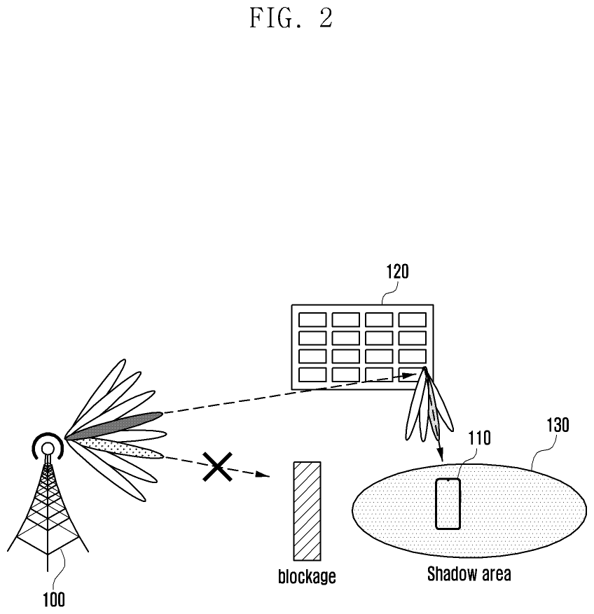

FIG. 2 is a diagram illustrating a scenario where a UE is located inside a shadow area in a wireless communication system including an RIS.

Referring to FIG. 2, when the UE 110 is located inside the shadow area 130, the UE 110 may transmit and receive a signal to which a reflection pattern is applied by the RIS 120. As illustrated in FIG. 2, if the UE 110 is located inside the shadow area 130, the strength of the signal transmitted and received between the UE 110 and the base station 100 may be low due to a blockage, and the strength of the signal transmitted and received via the RIS 120 may be high. As described above, a state where the UE 110 is located inside the shadow area 130, whereby the signal directly transmitted to and received from the base station 100 is attenuated and a signal to which a reflection pattern is applied by the RIS 120 is transmitted and received may be defined as the UE being in an RIS association. In addition, a state of being in an RIS association may also be called “RIS on,” and a state of not being in an RIS association may also be called “RIS off.”

Meanwhile, both when the UE 110 is located outside the shadow area 130 and when the UE 110 is located inside the shadow area 130, the signal to which a reflection pattern is applied by the RIS 120 may be measured most strongly. Accordingly, the disclosure provides a method by which a UE and/or a base station determines an RIS association so as to enable more efficient operation of the system, based on the background described above.

For example, the number of beams operable by the base station may be defined as M, and the number of reflection patterns operated through the RIS may be defined as K. If it is unknown whether the UE is in an RIS association, use of M+K reference signals (RSs) may be required for beam management. Here, the RS may be a channel state information reference signal (CSI-RS), a synchronization signal block (SSB), a sounding reference signal (SRS), or a newly defined reference signal. If whether the UE is in an RIS association is identified, the following operation may be possible.

First, if the UE is not in an RIS association and directly transmits and receives a signal to and from the base station, the base station may configure an RS such that the UE sweeps only a beam set directly transmitted from the base station. In the above example, the base station may configure a maximum of M RSs.

Second, if the UE is in an RIS association and thus transmits and receives a signal to which a reflection pattern is applied by the RIS, the base station may configure an RS such that the UE sweeps only reflection patterns of the RIS or only a set of beams corresponding to the reflection patterns. In the above example, the base station may configure a maximum of K RSs. In addition, in this case, performance gain may be increased by operating with reduced spacing between beams used for beam management.

Hereinafter, a method for determining an RIS association at the time of initial access is described.

According to an embodiment of the disclosure, a synchronization signal (or SSB, hereinafter used interchangeably) for determining an RIS association at the time of initial access may be configured.

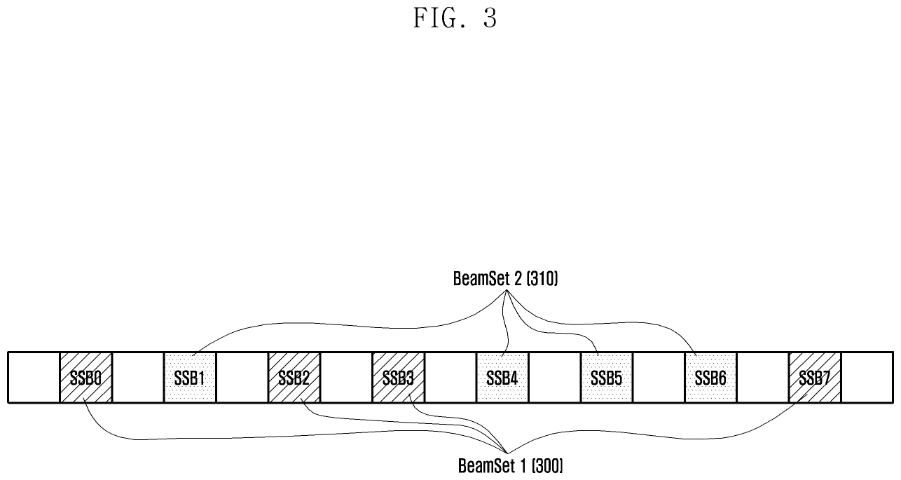

FIG. 3 is a diagram illustrating an example of a configuration of synchronization signal sets for determining an RIS association according to an embodiment of the disclosure.

Referring to FIG. 3, the base station may operate SSBs by separating a set 300 (hereinafter, beam set 1) of SSBs associated with beams directly transmitted from the base station and a set 310 (hereinafter, beam set 2) of SSBs associated with reflection patterns (or beams corresponding to the reflection patterns) of the RIS.

In an example, the base station may explicitly indicate, for each SSB to the UE, whether the SSB is included in beam set 1 300 or beam set 2 310.

For example, the base station may include information of a bitmap form indicating an RIS association of an SSB in a physical broadcast channel (PBCH) payload or a master information block (MIB) and transmit the information to the UE. SSBs corresponding to beam set 1 300 in the bitmap are indicated as “0,” and SSBs corresponding to beam set 2 310 are indicated as “1.” As illustrated in FIG. 3, the bitmap is set to {01001110} and may be transmitted to the UE through a PBCH payload or MIB. Alternatively, SSBs corresponding to beam set 1 300 in the bitmap are indicated as “1,” and SSBs corresponding to beam set 2 310 are indicated as “0.” As illustrated in FIG. 3, the bitmap is set to {10110001} and may be transmitted to the UE through a PBCH payload or MIB.

As another example, patterns configured by combinations of beam set 1 300 and beam set 2 310 may be previously defined, and the base station may transmit, to the UE, a PBCH payload or MIB including information indicating one pattern among the pre-defined patterns.

As another example, patterns configured by combinations of beam set 1 300 and beam set 2 310 may be previously defined, and the base station may transmit, to the UE, downlink control information (DCI) including information indicating one pattern among the pre-defined patterns. Alternatively, patterns configured by combinations of beam set 1 300 and beam set 2 310 may be previously defined, and the base station may transmit, to the UE, a PBCH payload or MIB including information indicating at least one candidate pattern among the pre-defined patterns, and then transmit, to the UE, DCI including information indicating one pattern among the at least one candidate pattern.

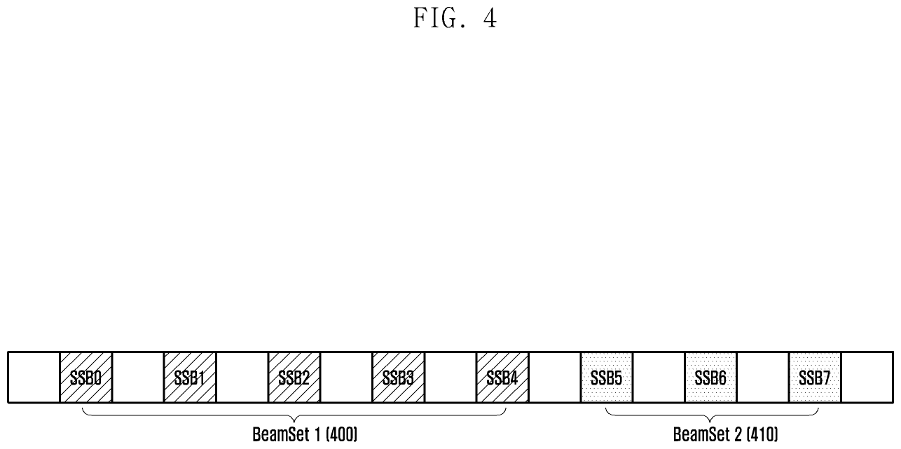

FIG. 4 is a diagram illustrating another example of a configuration of synchronization signal sets for determining an RIS association according to an embodiment of the disclosure.

Referring to FIG. 4, the base station may operate SSBs by separating a set 400 (hereinafter, beam set 1) of SSBs associated with beams directly transmitted from the base station and a set 410 (hereinafter, beam set 2) of SSBs associated with reflection patterns (or beams corresponding to the reflection patterns) of the RIS.

In an example, the base station may indicate, to the UE, a time point at which beam set 1 400 and beam set 2 410 are separated from each other.

For example, the base station may transmit, to the UE through an MIB, 1-bit information that toggles at a time point at which beam set 1 400 is changed to beam set 2 410 (or beam set 2 410 is changed to beam set 1 400).

As another example, the base station may transmit, through an MIB, N-bit information indicating an SSB index immediately before or after the change from beam set 1 400 to beam set 2 410 (or from beam set 2 410 to beam set 1 400). Here, the value of N may be represented as shown by Equation 1 below when a total number of SSBs included in beam set 1 400 and beam set 2 410 is N_{ssb}.

$$N = ( {log}_{2} {N}_{ssb} ) \qquad Equation 1$$

As another example, the base station may transmit, through a PBCH payload or system information block 1 (SIB 1), N-bit information indicating an SSB index immediately before or after the change from beam set 1 400 to beam set 2 410 (or from beam set 2 410 to beam set 1 400). Here, the value of N may be represented as shown by Equation 1 described above.

As another example, the base station may transmit, through DCI (e.g., DCI format 1_0), N-bit information indicating an SSB index immediately before or after the change from beam set 1 400 to beam set 2 410 (or from beam set 2 410 to beam set 1 400). Here, the value of N may be represented as shown by Equation 1 described above.

In an example, the positions of beam set 1 400 and beam set 2 410 are previously defined in a specification, and SSBs may be transmitted on the pre-defined positions. The UE may select an SSB for synchronization and determine the SSB index of the selected SSB and which beam set the SSB corresponds to.

According to an embodiment of the disclosure, the base station may determine whether the UE is in an RIS association, based on a measurement value of a synchronization signal at the time of initial access of the UE.

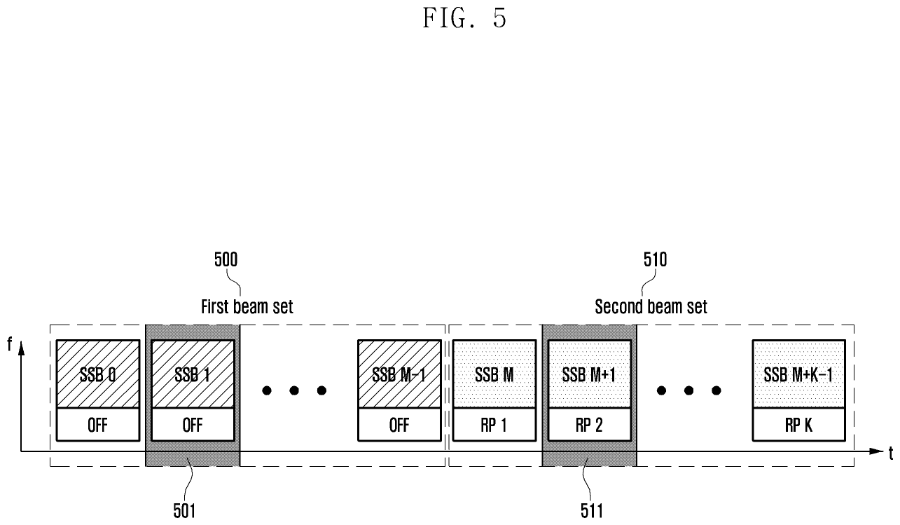

FIG. 5 is a diagram illustrating a synchronization signal with the maximum RSRP value in each synchronization signal set for determining an RIS association according to an embodiment of the disclosure.

Through the method described above with reference to FIGS. 3 and 4, a set 500 (hereinafter, beam set 1) of SSBs associated with beams directly transmitted from the base station and a set 510 (hereinafter, beam set 2) of SSBs associated with reflection patterns (or beams corresponding to the reflection patterns) of the RIS may be configured for the UE.

In an example, the UE may measure the SSBs of beam set 1 500 to derive a maximum reference signal received power (RSRP) value 501. In addition, the UE may measure the SSBs of beam set 2 510 to derive a maximum RSRP value 511. The UE may report, to the base station, the two maximum RSRP values 501 and 511 corresponding to beam set 1 500 and beam set 2 510, respectively. The UE may report, to the base station, the two maximum RSRP values 501 and 511 through a physical uplink shared channel (PUSCH) of message 3 (Msg 3) in a random access procedure. The base station may determine whether the UE is in an RIS association, based on the two maximum RSRP values 501 and 511 received from the UE. For example, if the maximum RSRP value 501 corresponding to beam set 1 500 is greater than (or equal to or greater than) the maximum RSRP value 511 corresponding to beam set 2 510, the base station may determine that the UE is not in an RIS association. For example, if the maximum RSRP value 511 corresponding to beam set 2 510 is greater than (or equal to or greater than) the maximum RSRP value 501 corresponding to beam set 1 500, the base station may calculate the difference between the two maximum RSRP values 501 and 511. Thereafter, if the difference value is greater than (or equal to or greater than) a particular threshold value for determining an RIS association, the base station may determine that the UE is in an RIS association. The threshold value may be a fixed value that is previously defined, and may vary according to a time point at which an RIS association is determined.

In an example, the UE may measure the SSBs of beam set 1 500 to derive an RSRP value(s) exceeding a first threshold value. In addition, the UE may measure the SSBs of beam set 2 510 to derive an RSRP value(s) exceeding a second threshold value. The first threshold value and the second threshold value may be equal to or different from each other. In addition, the first threshold value and the second threshold value may be previously configured for the UE through a PBCH payload, an MIB, or SIB1. The UE may report, to the base station, the RSRP value(s) exceeding the first threshold value corresponding to beam set 1 500 and the RSRP value(s) exceeding the second threshold value corresponding to beam set 2 510. In this case, the UE may report, to the base station through a PUSCH of Msg 3 in a random access procedure, the RSRP value(s) exceeding the first threshold value corresponding to beam set 1 500 and the RSRP value(s) exceeding the second threshold value corresponding to beam set 2 510. The base station may distinguish the RSRP values received from the UE into respective beam sets and then derive the two maximum RSRP values 501 and 511 corresponding to beam set 1 500 and beam set 2 510, respectively. The base station may determine whether the UE is in an RIS association, based on the derived two maximum RSRP values 501 and 511. For example, if the maximum RSRP value 501 corresponding to beam set 1 500 is greater than (or equal to or greater than) the maximum RSRP value 511 corresponding to beam set 2 510, the base station may determine that the UE is not in an RIS association. For example, if the maximum RSRP value 511 corresponding to beam set 2 510 is greater than (or equal to or greater than) the maximum RSRP value 501 corresponding to beam set 1 500, the base station may calculate the difference between the two maximum RSRP values 501 and 511. Thereafter, if the difference value is greater than (or equal to or greater than) a third threshold value for determining an RIS association, the base station may determine that the UE is in an RIS association. The third threshold value may be a fixed value that is previously defined, and may vary according to a time point at which an RIS association is determined.

According to an embodiment of the disclosure, the UE may determine an RIS association, based on a measurement value of a synchronization signal at the time of initial access.

Referring to FIG. 5, the UE may measure the SSBs of beam set 1 500 to derive the maximum RSRP value 501. In addition, the UE may measure the SSBs of beam set 2 510 to derive the maximum RSRP value 511.

The UE may determine an RIS association, based on the derived two maximum RSRP values 501 and 511. For example, if the maximum RSRP value 501 corresponding to beam set 1 500 is greater than (or equal to or greater than) the maximum RSRP value 511 corresponding to beam set 2 510, the UE may determine that the UE is not in an RIS association. For example, if the maximum RSRP value 511 corresponding to beam set 2 510 is greater than (or equal to or greater than) the maximum RSRP value 501 corresponding to beam set 1 500, the UE may calculate the difference between the two maximum RSRP values 501 and 511. Thereafter, if the difference value is greater than (or equal to or greater than) a particular threshold value for determining an RIS association, the UE may determine that the UE is in an RIS association. The threshold value may be a fixed value that is previously defined, may vary according to a time point at which an RIS association is determined, or may be configured by the base station through a PBCH payload or MIB.

Thereafter, the UE may report whether the UE is in an RIS association to the base station.

For example, the UE may transmit, to the base station through a PUSCH of Msg 3 in a random access procedure, at least one of the maximum RSRP value 501 corresponding to beam set 1 500, the maximum RSRP value 511 corresponding to beam set 2 510, and information indicating whether the UE is in an RIS association.

As another example, the UE may transmit the information indicating whether the UE is in an RIS association to the base station through a random access channel (RACH) resource. Here, RACH resources may be mapped to SSBs, and thus the base station may identify an RACH resource on which the information is transmitted, thereby identifying information on a beam (or SSB index) corresponding to one of the maximum RSRP values 501 and 511 corresponding to the respective beam sets together.

The UE and/or the base station determine an RIS association according to the above method, and then a beam sweeping method according to the presence or absence of the RIS association may be operated for a predetermined period. Here, the period value may be previously defined or configured through a PBCH payload or MIB. For example, if the UE is not in an RIS association, sweeping may be performed only for a beam set directly transmitted from the base station. Alternatively, if the UE is in an RIS association, sweeping may be performed for only reflection patterns of the RIS or only a set of beams corresponding to the reflection patterns.

Hereinafter, a method for determining an RIS association when the UE is in a mode of being connected with the base station is described.

According to an embodiment of the disclosure, the base station may separate a set (hereinafter, beam set 1) of RSs associated with beams directly transmitted from the base station and a set (hereinafter, beam set 2) of RSs associated with reflection patterns (or beams corresponding to the reflection patterns) of the RIS to configure beam sets 1 and 2 for the UE. Here, the RSs included in beam sets 1 and 2 may be configured by only SSBs, only CSI-RSs, or a combination of SSBs and CSI-RSs. Alternatively, a newly defined reference signal may be used for determining an RIS association.

In an example, in a case where the RSs included in beam sets 1 and 2 are configured by only SSBs, the base station may configure beam sets 1 and 2 for the UE in a method similar to the method described in the above description for FIGS. 3 and 4.

In an example, in a case where the RSs included in beam sets 1 and 2 are configured by only CSI-RSs or a combination of SSBs and CSI-RSs, the base station may semi-persistently configure beam sets 1 and 2 through RRC signaling. Alternatively, the base station may semi-persistently configure multiple beam sets for the UE through RRC signaling and then dynamically indicate, through DCI, a beam set corresponding to beam set 1 (or beam set 2) among the configured beam sets.

According to an embodiment of the disclosure, the base station may determine whether the UE is in an RIS association, based on an RS measurement value of the UE in a connected mode.

In an example, the UE may measure the RSs of beam set 1 to derive a maximum RSRP value. In addition, the UE may measure the RSs of beam set 2 to derive a maximum RSRP value. The UE may report, to the base station, the two maximum RSRP values corresponding to beam set 1 and beam set 2, respectively. In this case, the UE may report the two maximum RSRP values to the base station through a PUCCH, a PUSCH, or a MAC CE. The base station may determine whether the UE is in an RIS association, based on the two maximum RSRP values received from the UE. For example, if the maximum RSRP value corresponding to beam set 1 is greater than (or equal to or greater than) the maximum RSRP value corresponding to beam set 2, the base station may determine that the UE is not in an RIS association. For example, if the maximum RSRP value corresponding to beam set 2 is greater than (or equal to or greater than) the maximum RSRP value corresponding to beam set 1, the base station may calculate the difference between the two maximum RSRP values. Thereafter, if the difference value is greater than (or equal to or greater than) a particular threshold value for determining an RIS association, the base station may determine that the UE is in an RIS association. The threshold value may be a fixed value that is previously defined, and may vary according to a time point at which an RIS association is determined.

In an example, the UE may measure the RSs of beam set 1 to derive an RSRP value(s) exceeding a first threshold value. In addition, the UE may measure the RSs of beam set 2 to derive an RSRP value(s) exceeding a second threshold value. The first threshold value and the second threshold value may be equal to or different from each other. In addition, the first threshold value and the second threshold value may be previously configured for the UE through RRC signaling. The UE may report, to the base station, the RSRP value(s) exceeding the first threshold value corresponding to beam set 1 and the RSRP value(s) exceeding the second threshold value corresponding to beam set 2. In this case, the UE may report, to the base station through a PUCCH, a PUSCH, or a MAC CE, the RSRP value(s) exceeding the first threshold value corresponding to beam set 1 and the RSRP value(s) exceeding the second threshold value corresponding to beam set 2. The base station may distinguish the RSRP values received from the UE into respective beam sets and then derive two maximum RSRP values corresponding to beam set 1 and beam set 2, respectively. The base station may determine whether the UE is in an RIS association, based on the derived two maximum RSRP values. For example, if the maximum RSRP value corresponding to beam set 1 is greater than (or equal to or greater than) the maximum RSRP value corresponding to beam set 2, the base station may determine that the UE is not in an RIS association. For example, if the maximum RSRP value corresponding to beam set 2 is greater than (or equal to or greater than) the maximum RSRP value corresponding to beam set 1, the base station may calculate the difference between the two maximum RSRP values. Thereafter, if the difference value is greater than (or equal to or greater than) a third threshold value for determining an RIS association, the base station may determine that the UE is in an RIS association. The third threshold value may be a fixed value that is previously defined, and may vary according to a time point at which an RIS association is determined.

According to an embodiment of the disclosure, the UE in a connected mode may determine an RIS association, based on an RS measurement value.

First, the base station may configure, for the UE through RRC signaling, information on a time point and a period for performing an operation of determining an RIS association by the UE. For example, an RRC message transmitted to the UE may include information on a time offset and/or period for determining an RIS association. Here, the time offset and/or period may be indicated through a system frame number, a slot, and/or an OFDM symbol.

The UE may measure the RSs of beam set 1 to derive a maximum RSRP value. In addition, the UE may measure the RSs of beam set 2 to derive a maximum RSRP value.

The UE may determine an RIS association, based on the derived two maximum RSRP values. For example, if the maximum RSRP value corresponding to beam set 1 is greater than (or equal to or greater than) the maximum RSRP value corresponding to beam set 2, the UE may determine that the UE is not in an RIS association. For example, if the maximum RSRP value corresponding to beam set 2 is greater than (or equal to or greater than) the maximum RSRP value corresponding to beam set 1, the UE may calculate the difference between the two maximum RSRP values. Thereafter, if the difference value is greater than (or equal to or greater than) a particular threshold value for determining an RIS association, the UE may determine that the UE is in an RIS association. The threshold value may be a fixed value that is previously defined, may vary according to a time point at which an RIS association is determined, or may be previously configured by the base station through RRC signaling.

Thereafter, the UE may report whether the UE is in an RIS association to the base station.

For example, the UE may transmit, to the base station through a physical uplink control channel (PUCCH), uplink control information (UCI) including at least one of the maximum RSRP value corresponding to beam set 1, the maximum RSRP value corresponding to beam set 2, and information indicating whether the UE is in an RIS association.

As another example, the UE may transmit, to the base station through a PUSCH or MAC CE, at least one of the maximum RSRP value corresponding to beam set 1, the maximum RSRP value corresponding to beam set 2, and information indicating whether the UE is in an RIS association.

The UE and/or the base station determine an RIS association according to the above method, and then a beam sweeping method according to the presence or absence of the RIS association may be operated for a predetermined period. Here, the period value may be previously defined or configured through RRC signaling. For example, if the UE is not in an RIS association, sweeping may be performed only for a beam set directly transmitted from the base station. Alternatively, if the UE is in an RIS association, sweeping may be performed for only reflection patterns of the RIS or only a set of beams corresponding to the reflection patterns.

Hereinafter, a method of (re) determining an RIS association by the mobility of the UE in a connected mode is described.

In an example, when a beam failure, a radio link failure (RLF), or a handover failure (HOF) occurs due to the movement of the UE in a connected mode, the same method as the method of determining an RIS association at the time of initial access described above may be applied.

In an example, the base station may configure a period value for determining an RIS association for the UE through RRC signaling, and the UE may periodically determine whether the UE is in an RIS association according to the configured period value. In this case, the same method as the method of determining an RIS association by the UE in a connected mode described above may be applied Alternatively, the base station may periodically determine whether the UE is in an RIS association according to a predetermined period. In this case, the same method as the method of determining an RIS association by the base station when the UE is in a connected mode described above may be applied.

In an example, the base station may indicate a search space and/or beam set to the UE through DCI at a random time point to trigger determination of an RIS association.

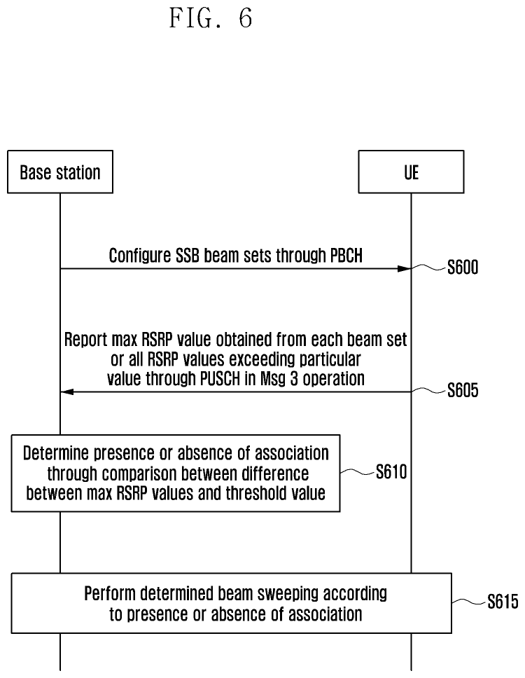

FIG. 6 is a sequence diagram illustrating a method by which a base station determines an RIS association, based on a measurement value of a synchronization signal at the time of initial access of a UE according to an embodiment of the disclosure.

In operation S600, a base station may transmit, to a UE, a PBCH payload or MIB including configuration information on synchronization signal sets for determining an RIS association.

In an example, through the method described above with reference to FIGS. 3 and 4, the base station may configure, for the UE, a set (hereinafter, beam set 1) of SSBs associated with beams directly transmitted from the base station and a set (hereinafter, beam set 2) of SSBs associated with reflection patterns (or beams corresponding to the reflection patterns) of an RIS.

In operation S605, the UE may report, to the base station, a maximum RSRP value obtained from each beam set or RSRP values exceeding a particular threshold value in each beam set.

In an example, the UE may measure the SSBs of beam set 1 to derive a maximum reference signal received power (RSRP) value. In addition, the UE may measure the SSBs of beam set 2 to derive a maximum RSRP value. The UE may report, to the base station, the two maximum RSRP values corresponding to beam set 1 and beam set 2, respectively. In this case, the UE may report the two maximum RSRP values to the base station through a PUSCH of Msg 3 in a random access procedure.

In an example, the UE may measure the SSBs of beam set 1 to derive an RSRP value(s) exceeding a first threshold value. In addition, the UE may measure the SSBs of beam set 2 to derive an RSRP value(s) exceeding a second threshold value. The first threshold value and the second threshold value may be equal to or different from each other. In addition, the first threshold value and the second threshold value may be previously configured for the UE through a PBCH payload, an MIB, or SIB1. For example, the first threshold value and the second threshold value may be included in the PBCH payload or MIB of operation S600 above. The UE may report, to the base station, the RSRP value(s) exceeding the first threshold value corresponding to beam set 1 and the RSRP value(s) exceeding the second threshold value corresponding to beam set 2. In this case, the UE may report, to the base station through a PUSCH of Msg 3 in a random access procedure, the RSRP value(s) exceeding the first threshold value corresponding to beam set 1 and the RSRP value(s) exceeding the second threshold value corresponding to beam set 2.

In operation S610, the base station may determine whether the UE is in an RIS association, based on information reported from the UE.

In an example, the base station may determine whether the UE is in an RIS association, based on the respective maximum RSRP values of beam sets 1 and 2 received from the UE in operation S605. For example, if the maximum RSRP value corresponding to beam set 1 is greater than (or equal to or greater than) the maximum RSRP value corresponding to beam set 2, the base station may determine that the UE is not in an RIS association. For example, if the maximum RSRP value corresponding to beam set 2 is greater than (or equal to or greater than) the maximum RSRP value corresponding to beam set 1, the base station may calculate the difference between the two maximum RSRP values. Thereafter, if the difference value is greater than (or equal to or greater than) a particular threshold value for determining an RIS association, the base station may determine that the UE is in an RIS association. The threshold value may be a fixed value that is previously defined, and may vary according to a time point at which an RIS association is determined.

In an example, the base station may distinguish the RSRP values (the RSRP value(s) exceeding the first threshold value corresponding to beam set 1 and the RSRP value(s) exceeding the second threshold value corresponding to beam set 2) received from the UE in operation S605 into respective beam sets and then derive the two maximum RSRP values corresponding to beam set 1 and beam set 2, respectively. The base station may determine whether the UE is in an RIS association, based on the derived two maximum RSRP values. For example, if the maximum RSRP value corresponding to beam set 1 is greater than (or equal to or greater than) the maximum RSRP value corresponding to beam set 2, the base station may determine that the UE is not in an RIS association. For example, if the maximum RSRP value corresponding to beam set 2 is greater than (or equal to or greater than) the maximum RSRP value corresponding to beam set 1, the base station may calculate the difference between the two maximum RSRP values. Thereafter, if the difference value is greater than (or equal to or greater than) a third threshold value for determining an RIS association, the base station may determine that the UE is in an RIS association. The third threshold value may be a fixed value that is previously defined, and may vary according to a time point at which an RIS association is determined.

In operation S615, the base station may determine an RIS association of the UE according to operation S610, and then a beam sweeping method according to the presence or absence of the RIS association may be operated for a predetermined period. Here, the period value may be previously defined or configured through a PBCH payload or MIB. For example, if the UE is not in an RIS association, sweeping may be performed only for a beam set directly transmitted from the base station. Alternatively, if the UE is in an RIS association, sweeping may be performed for only reflection patterns of the RIS or only a set of beams corresponding to the reflection patterns.

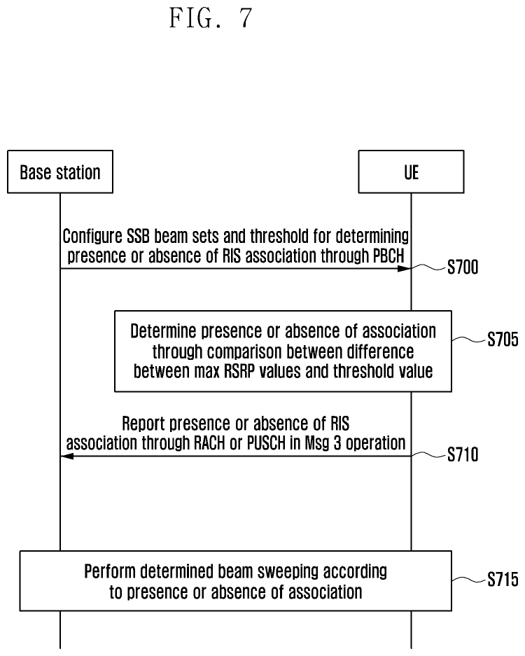

FIG. 7 is a sequence diagram illustrating a method by which a UE determines an RIS association, based on a measurement value of a synchronization signal at the time of initial access according to an embodiment of the disclosure.

In operation S700, a base station may transmit, to a UE, a PBCH payload or MIB including configuration information on synchronization signal sets for determining an RIS association and a particular threshold value for determining an RIS association.

In an example, through the method described above with reference to FIGS. 3 and 4, the base station may configure, for the UE, a set (hereinafter, beam set 1) of SSBs associated with beams directly transmitted from the base station and a set (hereinafter, beam set 2) of SSBs associated with reflection patterns (or beams corresponding to the reflection patterns) of an RIS, together with a particular threshold value for determining an RIS association.

In operation S705, the UE may determine whether the UE is in an RIS association, based on a measurement value of a synchronization signal.

In an example, the UE may measure the SSBs of beam set 1 to derive a maximum RSRP value. In addition, the UE may measure the SSBs of beam set 2 to derive a maximum RSRP value. The UE may determine an RIS association, based on the derived two maximum RSRP values. For example, if the maximum RSRP value corresponding to beam set 1 is greater than (or equal to or greater than) the maximum RSRP value corresponding to beam set 2, the UE may determine that the UE is not in an RIS association. For example, if the maximum RSRP value corresponding to beam set 2 is greater than (or equal to or greater than) the maximum RSRP value corresponding to beam set 1, the UE may calculate the difference between the two maximum RSRP values. Thereafter, if the difference value is greater than (or equal to or greater than) the particular threshold value configured in operation S700, the UE may determine that the UE is in an RIS association.

In operation S710, the UE may report whether the UE is in an RIS association to the base station.

In an example, the UE may transmit, to the base station through a PUSCH of Msg 3 in a random access procedure, at least one of the maximum RSRP value corresponding to beam set 1, the maximum RSRP value corresponding to beam set 2, and information indicating whether the UE is in an RIS association.

In an example, the UE may transmit the information indicating whether the UE is in an RIS association to the base station through a RACH resource. Here, RACH resources may be mapped to SSBs, and thus the base station may identify an RACH resource on which the information is transmitted, thereby identifying information on a beam (or SSB index) corresponding to one of the maximum RSRP values corresponding to the respective beam sets together.

In operation S715, the UE may determine an RIS association of the UE according to operation S710, and then a beam sweeping method according to the presence or absence of the RIS association may be operated for a predetermined period. Here, the period value may be previously defined or configured through a PBCH payload or MIB. For example, if the UE is not in an RIS association, sweeping may be performed only for a beam set directly transmitted from the base station. Alternatively, if the UE is in an RIS association, sweeping may be performed for only reflection patterns of the RIS or only a set of beams corresponding to the reflection patterns.

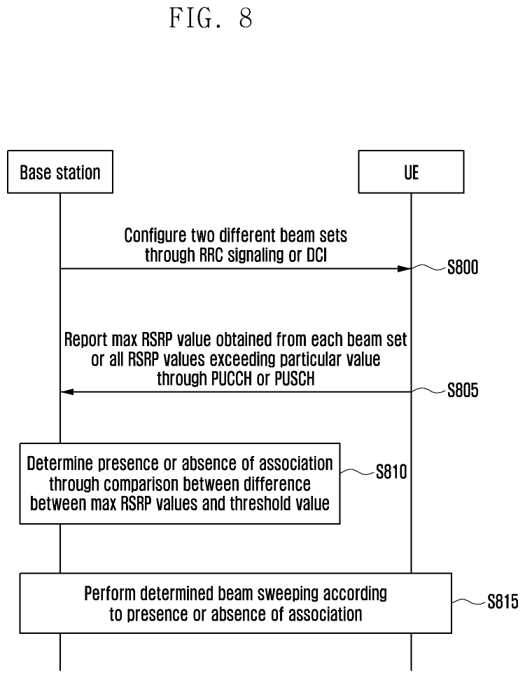

FIG. 8 is a sequence diagram illustrating a method by which a base station determines an RIS association, based on an RS measurement value of a UE in a connected mode according to an embodiment of the disclosure.

In operation S800, a base station may configure a set of RSs for determining an RIS association through RRC signaling and/or DCI.

For example, the base station may separate a set (hereinafter, beam set 1) of RSs associated with beams directly transmitted from the base station and a set (hereinafter, beam set 2) of RSs associated with reflection patterns (or beams corresponding to the reflection patterns) of the RIS to configure beam sets 1 and 2 for a UE. Here, the RSs included in beam sets 1 and 2 may be configured by only SSBs, only CSI-RSs, or a combination of SSBs and CSI-RSs. Alternatively, a newly defined reference signal may be used for determining an RIS association.

In an example, in a case where the RSs included in beam sets 1 and 2 are configured by only SSBs, the base station may configure beam sets 1 and 2 for the UE in a method similar to the method described in the above description for FIGS. 3 and 4.

In an example, in a case where the RSs included in beam sets 1 and 2 are configured by only CSI-RSs or a combination of SSBs and CSI-RSs, the base station may semi-persistently configure beam sets 1 and 2 through RRC signaling. Alternatively, the base station may semi-persistently configure multiple beam sets for the UE through RRC signaling and then dynamically indicate, through DCI, a beam set corresponding to beam set 1 (or beam set 2) among the configured beam sets.

In operation S805, the UE may report, to the base station, a maximum RSRP value obtained from each beam set or RSRP values exceeding a particular threshold value in each beam set.

In an example, the UE may measure the RSs of beam set 1 to derive a maximum RSRP value. In addition, the UE may measure the RSs of beam set 2 to derive a maximum RSRP value. The UE may report, to the base station, the two maximum RSRP values corresponding to beam set 1 and beam set 2, respectively. In this case, the UE may report the two maximum RSRP values to the base station through a PUCCH, a PUSCH, or a MAC CE.

In an example, the UE may measure the RSs of beam set 1 to derive an RSRP value(s) exceeding a first threshold value. In addition, the UE may measure the RSs of beam set 2 to derive an RSRP value(s) exceeding a second threshold value. The first threshold value and the second threshold value may be equal to or different from each other. In addition, the first threshold value and the second threshold value may be previously configured for the UE through the RRC signaling of S800. The UE may report, to the base station, the RSRP value(s) exceeding the first threshold value corresponding to beam set 1 and the RSRP value(s) exceeding the second threshold value corresponding to beam set 2. In this case, the UE may report, to the base station through a PUCCH, a PUSCH, or a MAC CE, the RSRP value(s) exceeding the first threshold value corresponding to beam set 1 and the RSRP value(s) exceeding the second threshold value corresponding to beam set 2.

In operation S810, the base station may determine whether the UE is in an RIS association, based on information reported from the UE.

In an example, the base station may determine whether the UE is in an RIS association, based on the two maximum RSRP values received from the UE. For example, if the maximum RSRP value corresponding to beam set 1 is greater than (or equal to or greater than) the maximum RSRP value corresponding to beam set 2, the base station may determine that the UE is not in an RIS association. For example, if the maximum RSRP value corresponding to beam set 2 is greater than (or equal to or greater than) the maximum RSRP value corresponding to beam set 1, the base station may calculate the difference between the two maximum RSRP values. Thereafter, if the difference value is greater than (or equal to or greater than) a particular threshold value for determining an RIS association, the base station may determine that the UE is in an RIS association. The threshold value may be a fixed value that is previously defined, and may vary according to a time point at which an RIS association is determined.

In an example, the base station may distinguish the RSRP values received from the UE into respective beam sets and then derive two maximum RSRP values corresponding to beam set 1 and beam set 2, respectively. The base station may determine whether the UE is in an RIS association, based on the derived two maximum RSRP values. For example, if the maximum RSRP value corresponding to beam set 1 is greater than (or equal to or greater than) the maximum RSRP value corresponding to beam set 2, the base station may determine that the UE is not in an RIS association. For example, if the maximum RSRP value corresponding to beam set 2 is greater than (or equal to or greater than) the maximum RSRP value corresponding to beam set 1, the base station may calculate the difference between the two maximum RSRP values. Thereafter, if the difference value is greater than (or equal to or greater than) a third threshold value for determining an RIS association, the base station may determine that the UE is in an RIS association. The third threshold value may be a fixed value that is previously defined, and may vary according to a time point at which an RIS association is determined.

In operation S815, the base station may determine an RIS association of the UE according to operation S810, and then a beam sweeping method according to the presence or absence of the RIS association may be operated for a predetermined period. Here, the period value may be previously defined or configured through the RRC signaling of operation S800. For example, if the UE is not in an RIS association, sweeping may be performed only for a beam set directly transmitted from the base station. Alternatively, if the UE is in an RIS association, sweeping may be performed for only reflection patterns of the RIS or only a set of beams corresponding to the reflection patterns.

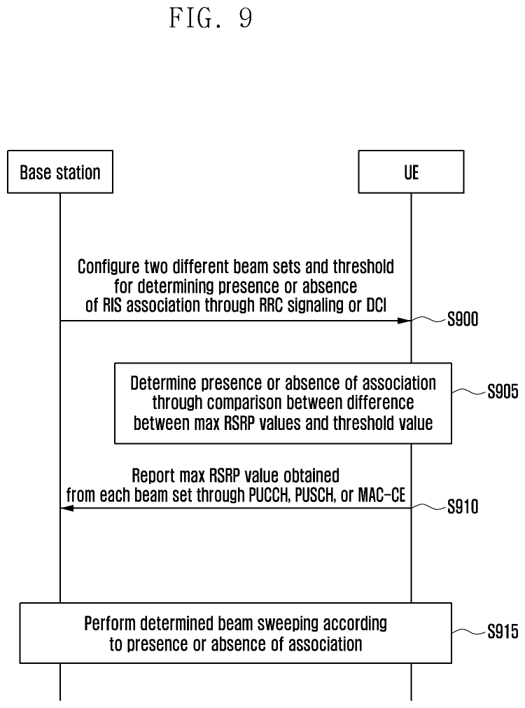

FIG. 9 is a sequence diagram illustrating a method by which a UE in a connected mode determines an RIS association, based on an RS measurement value according to an embodiment of the disclosure.

In operation S900, a base station may configure a set of RSs for determining an RIS association through RRC signaling and/or DCI.

For example, the base station may separate a set (hereinafter, beam set 1) of RSs associated with beams directly transmitted from the base station and a set (hereinafter, beam set 2) of RSs associated with reflection patterns (or beams corresponding to the reflection patterns) of the RIS to configure beam sets 1 and 2 for a UE. Here, the RSs included in beam sets 1 and 2 may be configured by only SSBs, only CSI-RSs, or a combination of SSBs and CSI-RSs. Alternatively, a newly defined reference signal may be used for determining an RIS association.

In an example, in a case where the RSs included in beam sets 1 and 2 are configured by only SSBs, the base station may configure beam sets 1 and 2 for the UE in a method similar to the method described in the above description for FIGS. 3 and 4.

In an example, in a case where the RSs included in beam sets 1 and 2 are configured by only CSI-RSs or a combination of SSBs and CSI-RSs, the base station may semi-persistently configure beam sets 1 and 2 through RRC signaling. Alternatively, the base station may semi-persistently configure multiple beam sets for the UE through RRC signaling and then dynamically indicate, through DCI, a beam set corresponding to beam set 1 (or beam set 2) among the configured beam sets.

In addition, the base station may configure a particular threshold value for determining an RIS association through the RRC signaling of operation S900.

In addition, the base station may configure information on a time point and a period at which the UE performs an operation of determining an RIS association through the RRC signaling of operation S900. For example, an RRC message transmitted to the UE may include information on a time offset and/or period for determining an RIS association. Here, the time offset and/or period may be indicated through a system frame number, a slot, and/or an OFDM symbol.

In operation S905, the UE may determine whether the UE is in an RIS association, based on an RS measurement value.

In an example, the UE may measure the RSs of beam set 1 to derive a maximum RSRP value. In addition, the UE may measure the RSs of beam set 2 to derive a maximum RSRP value. The UE may determine whether the UE is in an RIS association, based on the derived two maximum RSRP values. For example, if the maximum RSRP value corresponding to beam set 1 is greater than (or equal to or greater than) the maximum RSRP value corresponding to beam set 2, the UE may determine that the UE is not in an RIS association. For example, if the maximum RSRP value corresponding to beam set 2 is greater than (or equal to or greater than) the maximum RSRP value corresponding to beam set 1, the UE may calculate the difference between the two maximum RSRP values. Thereafter, if the difference value is greater than (or equal to or greater than) the particular threshold value configured in operation S900, the UE may determine that the UE is in an RIS association. Alternatively, the threshold value may be a fixed value that is previously defined, or may vary according to a time point at which an RIS association is determined.

In operation S910, the UE may report whether the UE is in an RIS association to the base station.

In an example, the UE may transmit, to the base station through a PUCCH, UCI including at least one of the maximum RSRP value corresponding to beam set 1, the maximum RSRP value corresponding to beam set 2, and information indicating whether the UE is in an RIS association.

In an example, the UE may transmit, to the base station through a PUSCH or MAC CE, at least one of the maximum RSRP value corresponding to beam set 1, the maximum RSRP value corresponding to beam set 2, and information indicating whether the UE is in an RIS association.

In operation S915, the UE may determine an RIS association of the UE according to operation S910, and then a beam sweeping method according to the presence or absence of the RIS association may be operated for a predetermined period. Here, the period value may be previously defined or configured through the RRC signaling of operation S900. For example, if the UE is not in an RIS association, sweeping may be performed only for a beam set directly transmitted from the base station. Alternatively, if the UE is in an RIS association, sweeping may be performed for only reflection patterns of the RIS or only a set of beams corresponding to the reflection patterns.

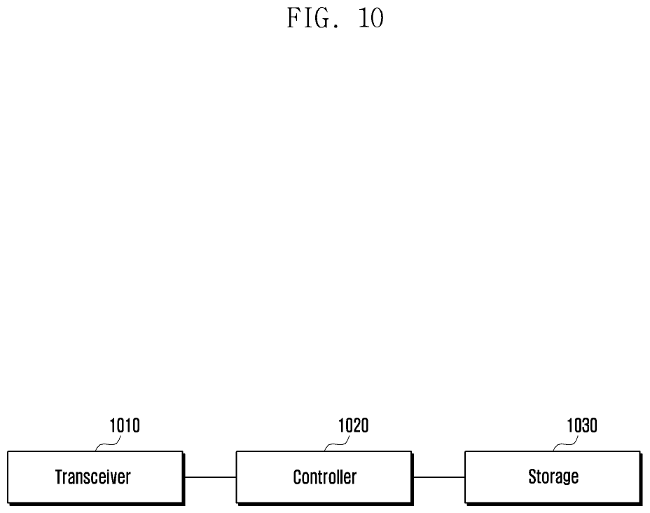

FIG. 10 illustrates a structure of a UE according to an embodiment of the disclosure.

Referring to FIG. 10, the UE may include a transceiver 1010, a controller 1020, and a storage 1030. In the disclosure, the controller may be defined as a circuit or an application-specific integrated circuit or at least one processor.

The transceiver 1010 may transmit/receive signals with other network entities. The transceiver 1010 may receive, for example, system information, control information, synchronization signals, or reference signals from the base station.

The controller 1020 may control the overall operation of the UE according to the embodiments proposed in the disclosure. For example, the controller 1020 may control signal flows between the respective blocks to perform operations according to the above-described flowcharts. Specifically, the controller 1020 may control the transceiver to receive information on a first beam set and a second beam set and information on a first threshold value from the base station, and may control the transceiver to determine whether the UE is in association with a reconfigurable intelligent surface (RIS), based on the first threshold value and measurement results for the first beam set and second beam set, and transmit, to the base station, information indicating whether the UE is in association with the RIS. Depending on whether the UE is in association with the RIS, beam sweeping may be performed based on one of the first beam set and the second beam set.

The storage 1030 may store at least one of information transmitted/received through the transceiver 1010 and information generated through the controller 1020.

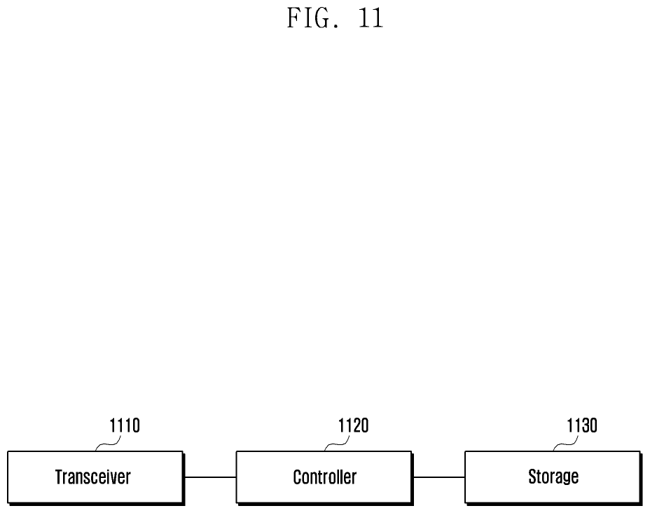

FIG. 11 illustrates a structure of a base station according to an embodiment of the disclosure.

Referring to FIG. 11, the base station may include a transceiver 1110, a controller 1120, and a storage 1130. In the disclosure, the controller may be defined as a circuit or an application-specific integrated circuit or at least one processor.

The transceiver 1110 may transmit/receive signals with other network entities. The transceiver 1110 may transmit, for example, system information, control information, data, synchronization signals, or reference signals to the UE.

The controller 1120 may control the overall operation of the base station according to the embodiments proposed in the disclosure. For example, the controller 1120 may control signal flows between the respective blocks to perform operations according to the above-described flowcharts. Specifically, the controller 1120 may control the transceiver to transmit information on a first beam set and a second beam set, may control the transceiver to receive measurement results for the first beam set and second beam set from the UE, and may determine whether the UE is in association with an RIS, based on the measurement results and a predetermined threshold value. Depending on whether the UE is in association with the RIS, beam sweeping may be performed based on one of the first beam set and the second beam set.

In addition, the storage 1130 may store at least one of information transmitted/received through the transceiver 1110 and information generated through the controller 1120.

In methods of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

Furthermore, although exemplary embodiments of the disclosure have been described and shown in the specification and the drawings by using particular terms, they have been used in a general sense merely to easily explain the technical contents of the disclosure and help understanding of the disclosure, and are not intended to limit the scope of the disclosure. It will be apparent to those skilled in the art that, in addition to the embodiments set forth herein, other variants based on the technical idea of the disclosure may be implemented.

1. A method performed by a terminal of a wireless communication system, the method comprising:
receiving, from a base station, information on a first beam set and a second beam set and information on a first threshold value;
determining whether the terminal is in a reconfigurable intelligent surface (RIS) association, based on a measurement result for the first beam set and the second beam set and the first threshold value; and
transmitting, to the base station, information indicating whether the terminal is in the RIS association,
wherein beam sweeping is performed based on one of the first beam set and the second beam set, depending on whether the terminal is in the RIS association.

2. The method of claim 1,
wherein the first beam set comprises at least one synchronization signal block (SSB) or at least one channel state information reference signal (CSI-RS) associated with a beam transmitted from the base station, and the second beam set comprises at least one SSB or at least one CSI-RS associated with a reflection pattern of an RIS, and
wherein the information on the first beam set and the second beam set is received through a physical broadcast channel (PBCH) payload, a master information block (MIB), or radio resource control (RRC) signaling.

3. The method of claim 1, wherein the determining of whether the terminal is in the RIS association comprises:
identifying a first RSRP value corresponding to the first beam set and a second RSRP value corresponding to the second beam set;
in case that the first RSRP value is equal to or smaller than the second RSRP value, identifying a difference between the first RSRP value and the second RSRP value; and
in case that the difference between the first RSRP value and the second RSRP value is equal to or greater than the first threshold value, determining that the terminal is in the RIS association.

4. The method of claim 1, wherein the determining of whether the terminal is in the RIS association comprises:
identifying a first RSRP value corresponding to the first beam set and a second RSRP value corresponding to the second beam set; and
in case that the first RSRP value is equal to or greater than the second RSRP value, determining that the terminal is not in the RIS association.

5. A method performed by a base station of a wireless communication system, the method comprising:
transmitting information on a first beam set and a second beam set to a terminal;
receiving a measurement result for the first beam set and the second beam set from the terminal; and
determining whether the terminal is in a reconfigurable intelligent surface (RIS) association, based on the measurement result and a predetermined threshold value,
wherein beam sweeping is performed based on one of the first beam set and the second beam set, depending on whether the terminal is in the RIS association.

6. The method of claim 5,
wherein the first beam set comprises at least one synchronization signal block (SSB) or at least one channel state information reference signal (CSI-RS) associated with a beam transmitted from the base station, and the second beam set comprises at least one SSB or at least one CSI-RS associated with a reflection pattern of an RIS, and
wherein the information on the first beam set and the second beam set is transmitted through a physical broadcast channel (PBCH) payload, a master information block (MIB), or radio resource control (RRC) signaling.

7. The method of claim 5, wherein the determining of whether the terminal is in the RIS association comprises:
identifying a first RSRP value corresponding to the first beam set and a second RSRP value corresponding to the second beam set;
in case that the first RSRP value is equal to or smaller than the second RSRP value, identifying a difference between the first RSRP value and the second RSRP value; and
in case that the difference between the first RSRP value and the second RSRP value is equal to or greater than the predetermined threshold value, determining that the terminal is in the RIS association.

8. The method of claim 5, wherein the determining of whether the terminal is in the RIS association comprises:
identifying a first RSRP value corresponding to the first beam set and a second RSRP value corresponding to the second beam set; and
in case that the first RSRP value is equal to or greater than the second RSRP value, determining that the terminal is not in the RIS association.

9. A terminal in a wireless communication system, the terminal comprising:
a transceiver; and
a controller,
wherein the controller is configured to:
control the transceiver to receive, from a base station, information on a first beam set and a second beam set and information on a first threshold value,
determine whether the terminal is in a reconfigurable intelligent surface (RIS) association, based on a measurement result for the first beam set and the second beam set and the first threshold value, and
control the transceiver to transmit, to the base station, information indicating whether the terminal is in the RIS association, and
wherein beam sweeping is performed based on one of the first beam set and the second beam set, depending on whether the terminal is in the RIS association.

10. The terminal of claim 9,
wherein the first beam set comprises at least one synchronization signal block (SSB) or at least one channel state information reference signal (CSI-RS) associated with a beam transmitted from the base station, and the second beam set comprises at least one SSB or at least one CSI-RS associated with a reflection pattern of an RIS, and
wherein the information on the first beam set and the second beam set is received through a physical broadcast channel (PBCH) payload, a master information block (MIB), or radio resource control (RRC) signaling.

11. The terminal of claim 9, wherein the controller is configured to:
identify a first RSRP value corresponding to the first beam set and a second RSRP value corresponding to the second beam set;
in case that the first RSRP value is equal to or smaller than the second RSRP value, identify a difference between the first RSRP value and the second RSRP value; and
in case that the difference between the first RSRP value and the second RSRP value is equal to or greater than the first threshold value, determine that the terminal is in the RIS association.

12. The terminal of claim 11, wherein the controller is configured to:
identify a first RSRP value corresponding to the first beam set and a second RSRP value corresponding to the second beam set; and
in case that the first RSRP value is equal to or greater than the second RSRP value, determine that the terminal is not in the RIS association.

13. A base station in a wireless communication system, the base station comprising:
a transceiver; and
a controller,
wherein the controller is configured to:
control the transceiver to transmit information on a first beam set and a second beam set to a terminal,
control the transceiver to receive a measurement result for the first beam set and the second beam set from the terminal, and
determine whether the terminal is in a reconfigurable intelligent surface (RIS) association, based on the measurement result and a predetermined threshold value, and
wherein beam sweeping is performed based on one of the first beam set and the second beam set according to whether the terminal is in the RIS association.

14. The base station of claim 13,
wherein the first beam set comprises at least one synchronization signal block (SSB) or at least one channel state information reference signal (CSI-RS) associated with a beam transmitted from the base station, and the second beam set comprises at least one SSB or at least one CSI-RS associated with a reflection pattern of an RIS, and
wherein the information on the first beam set and the second beam set is transmitted through a physical broadcast channel (PBCH) payload, a master information block (MIB), or radio resource control (RRC) signaling.

15. The base station of claim 13, wherein the controller is configured to:
identify a first RSRP value corresponding to the first beam set and a second RSRP value corresponding to the second beam set;
in case that the first RSRP value is equal to or greater than the second RSRP value, determine that the terminal is not in the RIS association;
in case that the first RSRP value is equal to or smaller than the second RSRP value, identify a difference between the first RSRP value and the second RSRP value; and
in case that the difference between the first RSRP value and the second RSRP value is equal to or greater than the predetermined threshold value, determine that the terminal is in the RIS association.
